(19) United States
(12) Patent Application Publication
(10) Pub. No.: US 2018/0015655 A1
(43) Pub. Date: Jan. 18, 2018

(54) DIMENSIONAL ACCURACY IN GENERATING 3D OBJECTS

(71) Applicant: Microsoft Technology Licensing, LLC, Redmond, WA (US)

(72) Inventors: Gheorghe Marius Gheorghescu, Sammamish, WA (US); Teddy Leland Bennett, Kirkland, WA (US); John Socha-Leialoha, Bellevue, WA (US)

(21) Appl. No.: 15/208,490

(22) Filed: Jul. 12, 2016

(51) Int. Cl. B29C 47/06

(52) U.S. Cl. CPC B29C 47/06; B33Y 50/00; B33Y 10/00; B33Y 30/00

(57) ABSTRACT

Methods, systems, and devices are described herein for improving dimensional accuracy in generating a three dimensional (3D) object. In one aspect, first data may be received, for example from a first sensor, with the first data corresponding to at least a first dimension or measurement of a filament extrudable by a 3D printer. Similarly, second data may be received, for example from a second sensor, with the second data corresponding to at least a second dimension of the filament extrudable by the 3D printer. Based on the first and the second data, an amount of filament provided to a hotend of the 3D printer may be determined. During generation of the 3D object, a speed at which the filament is provided to the hotend may be adjusted based on the determined amount of filament provided to the hotend to more accurately generate the 3D object.

### TECHNICAL FIELD

This disclosure relates generally to three-dimensional (3D) printing or additive manufacturing, and more specifically to improving dimensional accuracy in creating 3D objects.

### BACKGROUND

3D printers commonly print objects from 3D models generated from computer-aided design (CAD) applications, by slicing the model into thin horizontal layers and depositing material (e.g., melted plastic, clay, concrete, metal powder, food stuff) vertically layer by layer from bottom to top. One common method used to deposit materials (e.g., plastic, composites) supplied as filament wound on spools, onto a 3D printer surface where the object is formed (build plate), is through the use of an extruder that forces the filament into a “hotend” that melts the material which exits through a small-diameter (typical diameter 300-500 microns) nozzle. The printer moves the extruder or build plate in the x-y plane as required to form successive sliced layers, and moves the extruder up or the build plate down at the completion of each layer to begin extruding material for the next layer.

Typical 3D printers employ plastic/composite filament extruders that operate in an open-loop manner. The printer controller software interprets the G-code instructions generated by a slicer and output directly to a printer or stored as a file, and simply sends motor drive signals to the extruder motor (typically a stepper motor) that cause it to extrude material at a rate commanded by the G-code and translated based on parameters set in the print controller firmware (e.g., filament diameter, nozzle diameter).

While 3D printers are capable of producing x and y dimensional accuracy on the order of 2 microns, the x & y dimensional accuracy of printed objects will vary according to the diameter of the filament the printer controller uses to determine extrusion rates. Unfortunately, filament diameter can vary from one spool to another, and from one supplier to another, as much as 5%. When the filament diameter is larger than expected, the excess amount emerging from the extruder gets squished out at the sides of the extruder nozzle, increasing the width of the extrusion. When the filament diameter is smaller than expected, the smaller amount of extruded material may cause a decrease in adhesion to the layers below and adjacent to the current extrusion line, correspondingly reducing the strength of the printed object.

Further, the temperature at which plastic & composite filament undergo phase change from solid to liquid varies widely, as well as the temperature at which they achieve the optimal viscosity for extrusion speed, adhesion, and cooling. These wide variations in filament characteristics most commonly occur with different filament colors, different suppliers, different batches of the same color, and different filament composition (e.g., ABS, PLA, Nylon, Blended material composites).

Accordingly, improvements may be made in 3D printing to account for differences and variation in filaments used to generate a 3D object.

### SUMMARY

Illustrative examples of the disclosure include, without limitation, methods, systems, and various devices. In one aspect, dimensional accuracy in generating a 3-dimensional (3D) object may be improved. First data may be received, with the first data corresponding to at least a first dimension or measurement of a filament extrudable by a 3D printer. Similarly, second data may be received, with the second data corresponding to at least a second dimension of the filament extrudable by the 3D printer. Based on the first and the second data, an amount of filament provided to a hotend of the 3D printer may be determined. During generation of the 3D object, a speed at which the filament is provided to the hotend may be adjusted based on the determined amount of filament provided to the hotend to more accurately generate the 3D object.

In another aspect, a 3D printer may be calibrated. The calibration may include extruding by a motor, a filament through a hotend of a 3D printer at a first temperature, with the first temperature corresponding to a first drive force of the motor. The motor may be instructed to extrude the filament through the hotend at a second temperature, with the second temperature corresponding to a second drive force of the motor. An optimal extrusion viscosity of the filament may be obtained. A temperature of the hotend may be adjusted based on the optimal extrusion viscosity of the filament.

In another aspect, small features of a 3D printed object may be improved. First, a force surface for different extruder hotend temperatures and extrusion rates may be generated. Minimum and maximum extrusion rates may be determined for printing a layer of a 3D object. A target hotend temperature may be selected for the minimum extrusion rate for the layer based on a desired viscosity (force). A target hotend temperature may be selected for the maximum extrusion rate for the layer based on a desired viscosity (force). One or more target hotend temperatures may then be selected for extrusion rates between the maximum and minimum rates for the layer, based on determined or extrapolated forces from the generated force surface for each rate. A dynamic temperature profile may be generated corresponding to an extrusion rate profile for printing the layer, based on the target hotend temperatures for minimum to maximum extrusion rates.

In another aspect, 3D printer filament extrusion jams may be reduced and/or prevented. A force surface for different extruder hotend temperatures and extrusion rates may be generated. During extrusion, a measured filament drive force exceeding a force surface value at a measured temperature and extrusion rate may be detected. It may next be determined if the measured filament drive force for the measured temperature and extrusion rate exceeds the force surface value by an allowed amount. If so, the filament drive force may be decreased by, for example, changing the hotend temperature and/or extrusion rate to a force surface value that lowers the measured filament drive force.

Other features of the systems and methods are described below. The features, functions, and advantages can be achieved independently in various examples or may be combined in yet other examples, further details of which can be seen with reference to the following description and drawings.

### BRIEF DESCRIPTION OF THE DRAWINGS

Embodiments of the present disclosure will be described more fully hereinafter with reference to the accompanying drawings, in which:

FIG. 1 depicts an example of a computing device in communication with a three-dimensional (3D) printer capable of printing a 3D object.

FIGS. 2A and 2B depict example exploded views of an extrusion assembly and hotend of the 3D printer depicted in FIG. 1.

FIGS. 3A-3C depict example cross-sectional views of filaments in relation to two or more filament sensors.

FIG. 4 depicts an example of a more detailed perspective view of an arrangement of three displacement sensors/rollers positioned around a filament.

FIG. 5 depicts an example process for adjusting the speed at which filament is provided to the hotend of a 3D printer based on dimensional information of the filament.

FIGS. 6A and 6B depict example processes for calibrating a 3D printer.

FIG. 7 illustrates an example process for measuring a force surface.

FIG. 8A illustrates an example process for determining a target temperature for a given layer or layers to be generated by a 3D printing device, based on minimum and maximum extrusion rates.

FIG. 8B illustrates an example process for detecting a filament drive force exceeding a force surface value at a measured temperature and extrusion rate.

FIG. 9 depicts an example general purpose computing environment in which the techniques described herein may be embodied.

### DETAILED DESCRIPTION OF ILLUSTRATIVE EMBODIMENTS

Systems and techniques are described herein for improving the dimensional accuracy in generating a 3-dimensional (3D) object by adjusting the generation of the 3D object, such as via a 3D printer, according to the filament provided to the 3D printer. In one aspect, the filament or material used to generate the 3D object may be measured to determine an amount of filament that is provided to the hotend of the 3D printer. This may include obtaining first and second data corresponding to first and second dimensions or measurements of the filament, for example, by sensors, to determine or obtain a determined cross-sectional area of the filament. In some aspects, receiving the first and second data corresponding to first and second dimensions of the filament may be performed concurrently with the filament being provided to the hotend. In some cases, two or more displacement sensors may be used to measure the filament, such as at 90 or 120 degrees or other spacing about an axis of the filament, to improve accuracy of the measurement, particularly when the filament cross-section is irregular (i.e., not perfectly circular).

Based on the measurement(s) of the filament, an amount of filament delivered to the hotend of a 3D printer may be determined, for example, relative to a speed of extrusion of the filament. Upon initialization of the 3D printer with a given filament, and/or during generation of a 3D object, the speed at which the filament is provided to the hotend may be adjusted based on the determined amount of filament. This may be performed to ensure that a particular amount or volume of filament is provided to the hotend throughout the 3D printing process, irrespective of variations in the filament, to improve print consistency, accuracy, and structural integrity of the generated 3D object.

In some aspects, the measured amount of filament (e.g., cross-sectional area), may be provided to a control component of the 3D printer to form a feedback loop in real time or near real time during generation of the 3D object. In this way, instructions sent to the 3D printer, and more specifically the motor (e.g., stepper motor) or extrusion assembly, may be modified to adjust the filament drive rate during the 3D printing process. In some aspects, the measurements may be provided at various time intervals, constantly, upon detection of a change, etc., to enable dynamic adjustment of the 3D printer based on the filament being used.

In some aspects, measuring the filament diameter or cross-sectional area while it is in motion being driven into the extruder hotend may be accomplished with several different types of noncontact sensing technologies such as optical, laser, eddy-current, inductive, and capacitive sensors. Mechanical sensors such as a spring-loaded pinch-roller system with an angle or distance encoder that measures the gap between the pinch rollers in contact with the filament may also be used. One or more sensors can also be implemented on the commonly used pressure roller that pushes the filament against the Hobbs wheel mounted to the extruder stepper motor. The measured diameter may be used to adjust an extrusion-rate multiplier via a G-code command to the printer controller microprocessor. The choice of sensor may depend on, for example the resolution and accuracy required, sensor cost, sensing speed, mass, etc.

In another aspect, a 3D printer or other 3D generation device may be calibrated based on an optimal extrusion viscosity of a particular filament, the temperature of the extruder hotend, a speed at which the filament is driven, and the power or current drawn by a filament driving mechanism (e.g., motor) of the 3D printer. In one example, filament may be driven by a motor at a predetermined speed into a hotend of a 3D printer extruder at a first temperature. In some cases, the power or current drawn by/provided to the motor while driving the filament into the extruder hotend at the predetermined speed and at the first temperature, may be measured and/or recorded. The filament may be driven by the motor into the hotend of the 3D printer extruder at a second temperature, and a corresponding second drive force measured and/or recorded. Based on the filament material, manufacturer, color, diameter, or other filament characteristic, an optimal extrusion viscosity of the filament may be obtained. The temperature of the hotend may then be adjusted based on the optimal viscosity of the filament and the recorded drive force values. In some aspects, the temperature of the hotend may be changed one or multiple times in order to achieve the optimal or near-optimal viscosity based on the drive force.

In some aspects, to obtain consistent, repeatable 3D object prints independent of filament color or other filament characteristics, the filament melting temperature may be determined each time a new spool of filament is installed on a 3D printer. Since the viscosity of the melted filament varies with temperature, the force with which the cold filament is driven into the hotend of the extruder and pushed out of the nozzle with a given orifice at a given extrusion speed will vary proportionately. The amount of filament drive force can be calculated from the measured power being drawn by the electric motor at a given speed due to the fact that increasing load demands on an electric motor require increasing voltage or current, or may be determined by back EMF generated by the motor. The higher the hotend temperature, the lower the viscosity of the melted filament and correspondingly lower force & power required by the extruder filament drive motor. Other force sensors such as load cells, strain gauges, force-sensing resistors (FSR), piezo-electric transducers, etc., may be used instead of or in conjunction with motor power or torque sensing means.

It should be appreciated that the described techniques may be applied to various 3D object generation techniques utilizing one or more filaments of material whose phase or viscosity changes in response to temperature such as plastics (e.g., acrylonitrile butadiene styrene (ABS), polylactic acid (PLA), Nylon, composite plastic blends), foodstuff (e.g., chocolate, icing) et al., and using extrusion techniques including fused deposition modeling (FDM), fused filament fabrication (FFF), or other types of additive manufacturing techniques that use a slicing method.

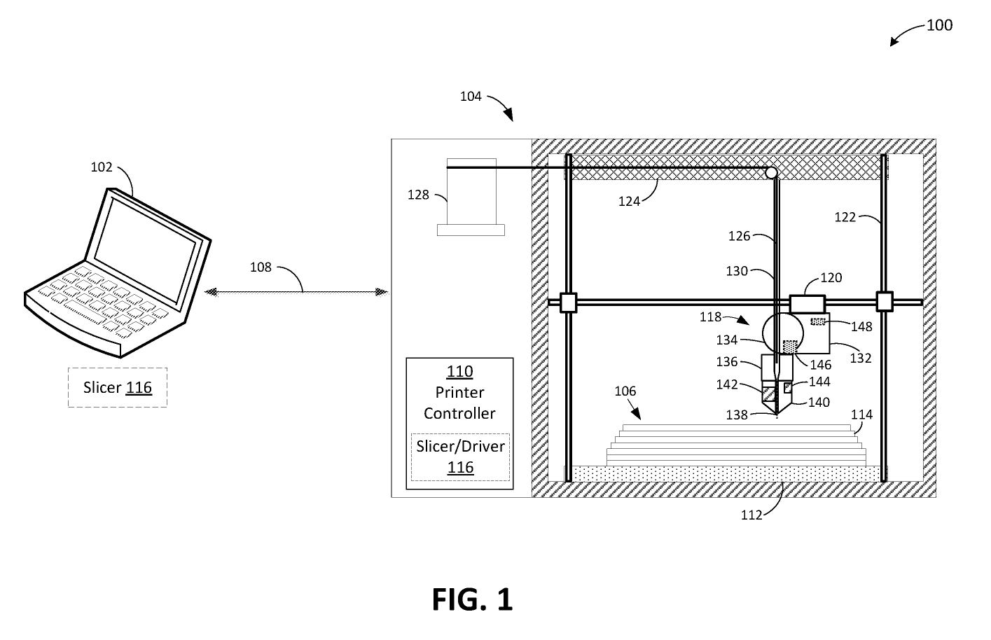

FIG. 1 illustrates an example system 100 including a computing device 102 in communication with a three dimensional (3D) printer 104 capable of or configured to print a 3D object 106. The computing device 102 may include any of a laptop, a desktop or personal computer (PC), mobile devices such as smart phones, tablets, etc., networked devices, cloud computing resources, or combinations thereof. The computing device 102 may communicate with 3D printer 104 via a wired connection or any of a variety of wireless connections 108, as are known to one of skill in the art. The 3D printer 104 may have or be associated with any of a variety of transceivers, modems, NICs, etc., typically associated with the printer controller 110, to communicate with computing device 102 via wired and/or wireless connection 108. In general, the computing device 102 may execute or access (via a network or via the cloud), one or more software programs or applications that take 3D object data and translate the data into instructions (e.g., G-code) executable by the printer controller 110 to control the 3D printer 104 to cause 3D printer 104 to form 3D object 106 by extruding material onto the base 112 in multiple (e.g., separately) configurable layers 114. For reference purposes, and as used throughout, the software application, which may in some cases include a computer aided design (CAD) component, a computer aided manufacturing (CAM) component, 3D image capture and translation functions, and so on, may be referred to as slicer or driver 116. Typically slicer 116 will be associated with the computing device 102 however, it is contemplated herein that slicer 116 may be in whole or in part associated with an individual 3D printer 104 that might, but not necessarily be, a function of or otherwise be contained within the printer controller 110, without departing from the techniques described herein.

The 3D printer 104 may include one or more extruder assemblies 118 positioned over an object base or bed 112. The extruder assembly 118 may be moved in one or more directions by movement means 120, which may include one or more stepper or servo motors, along rail system 122, as is generally known in the art. The movement means 120 may move the extruder assembly 118 in the vertical plane (z axis), and/or the horizontal plane (x or y axis), such as relative to the upper plate 124 and the base 112 along rail system 120. Other 3D printer 104 designs fix the extruder 118 in the z-axis and move it in the x-axis and y-axis while moving the bed 112 in the z-axis. Yet other designs move the extruder 118 in the z-axis and x-axis while moving the bed 112 in the y-axis. Still other designs operate using a polar coordinate system to move the extruder 118 over a stationary bed 112. The techniques described herein are applicable to these and other variations of 3D printer configurations (such as Delta Parallel Kinematic printers). In some aspects, the extruder assembly 118 may be configured to receive and extrude one or more filaments 126 supplied from one or more spools 128 upon which filament is wound/stored, and typically located apart from the extruder 118. In other cases, the filament 126 may be stored or housed in other portions of the 3D printer 104 or completely external to the 3D printer 104. The filament 126 may be housed in a filament casing 130, for example, to deliver the filament 126 to the extruder 118 unobstructed.

The extruder assembly 118 may include a motor 132 or other drive means connected to one or more drive gears 134 that move and control the rate at which the filament is delivered to hotend 136 via a rolling assembly (not shown). Other extruder assemblies (e.g., a Bowden extruder (not shown)) are configured with the motor 132 or other drive means connected to one or more drive gears 134 apart from the moveable extruder hotend 136, fixed to a stationary part of 3D printer 104 closer to the one or more filament spools, and with the filament routed through a filament guide to moveable extruder hotend 136. The hotend 136 may heat the filament 126 and extrude the viscous liquid filament 138 through nozzle 140 onto bed 112 or prior layer 114 to form 3D object 106. The hotend 136 may include a heating element 142 for heating the filament 126 into a viscous liquid state. The heating element 142 may be controlled to heat the filament at different rates or temperatures, etc. The hotend 136 may also include one or more temperature sensors 144 to aid in controlling heating element 142 during idle or active periods of 3D object generation.

According to the one aspect of the techniques described herein, one or more filament sensors 146 may be located in or proximate to the extruder assembly 118 to measure the amount of filament 126 entering the extruder 118, and in some cases the hotend 136. The filament sensors 146 may provide measurement information indicative of the cross-sectional area or amount of filament 126 provided to hotend 136 to printer controller 110 and/or slicer 116, which may, in turn, be used to adjust the speed at which filament 126 is provided to the hotend 136 via motor or drive mechanism 132. Adjusting the speed or flow at which the filament 126 is provided to the hotend 136 based on the cross-sectional area of the filament 126 may enable a more precise extrusion of melted filament 126 to form the 3D object 106, thus resulting in a more accurate 3D object 106 that is more aesthetically pleasing, has better cohesion between filament layers, and other benefits.

According to another aspect of the techniques described herein, a power or current sensor 148 or other device, wire, etc., for sensing power drawn by motor 132 may be electrically connected to the motor 132. The power sensor 148 may provide power information to the printer controller 110 and/or slicer 116. The printer controller 110 and/or slicer 116 may use the power information provided by the power sensor 148 and temperature information provided by temperature sensor 144 to calibrate the hotend 136, and mores specifically, the heating element 142, to heat the filament 126 in such a way as to achieve an optimal extrusion viscosity of the filament 126. This may additionally enable a more precise extrusion of melted filament 138 to form the 3D object 106, thus resulting in a more accurate 3D object that is more aesthetically pleasing, has better cohesion to the print bed 11 and between filament layers, and other benefits.

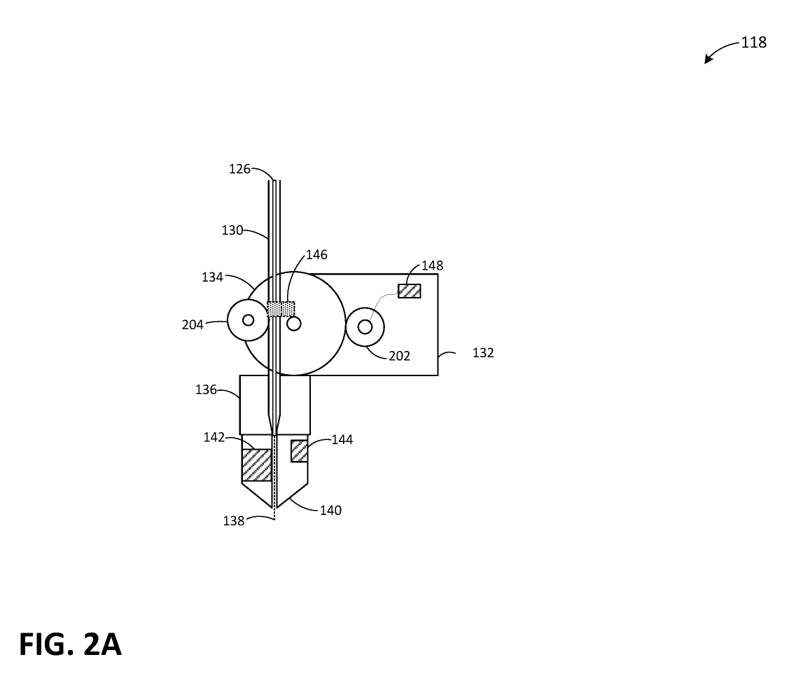

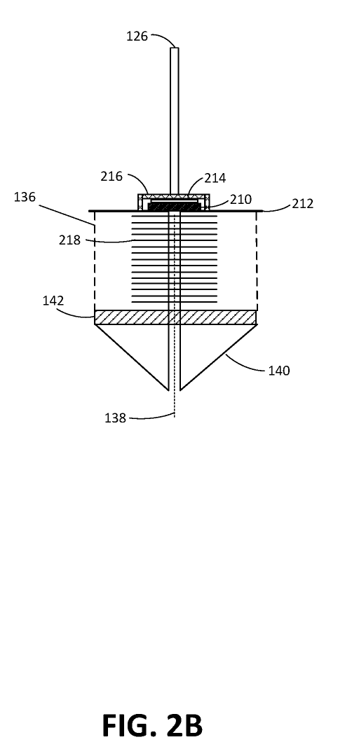

FIG. 2A illustrates an exploded, more detailed, view of extruder assembly 118 described in reference to FIG. 1. The drive means 132 may additionally include a primary drive shaft/gear 202, which may rotate larger drive gear 134. The larger drive gear 134 may interface with one or more rollers 204, such as pressure rollers, Hobbs wheels or pulleys, etc., for contacting and pushing filament 126 toward hotend 136, as are known in the art.

Many 3D printer users measure the filament diameter with calipers and enter the measured value into a setting of their slicer or print control software, used to adjust the extrusion rate for printing objects. Some 3D printer manufacturers design their printers to accept only filament cartridges they manufacture, allowing the manufacturers to ensure that the filament used in the printers they sell meets their specified tolerance. While this approach may ensure x & y dimensional accuracy of objects printed on these manufacturer's printers, the proprietary filament cartridges generally cost more than those available from competing suppliers that offer general purpose filament in standard diameters. In addition, this approach does not compensate for deformation after fabrication (for example knots or sharp turns in the filament, which are incurred when the filament is rolled onto the spool, or when the user loads the filament). Additional deformation can arise from the spool being impaired from spinning freely thus causing the filament to stretch. To preserve repeatable x & y dimensional accuracy of objects printed on most marketed printers, 3D printer users may benefit from an automated means of accurately determining the filament diameter in the spools purchase for use in their 3D printer, that will inform the controller 110 and/or motor 132 to adjust the filament extrusion rate to compensate for variations in filament diameter to repeatedly produce objects with consistently accurate x & y dimensions.

Designs, as herein described, have been developed to dynamically measure the filament 126 diameter as it is being forced through the extruder 118 before and/or when an object 106 is being printed. The 3D printer firmware, such as implemented in controller 110 and/or slicer 116, may process the measured diameter of the filament 126 and adjust the extrusion rate dynamically according to the measured diameter. The firmware, controller 110, or slicer 116 may compensate for the distance between the filament sensor(s) 146 and the hotend nozzle orifice 215 where the melted filament is finally extruded.

In one example, filament sensor(s) 146 may be positioned near or integrated with the one or more rollers 210 to provide a more accurate way to measure the amount of filament being delivered to hotend 136. In other cases, filament sensor(s) 146 may be provided along the filament in other locations, such as before or after drive mechanism 132, but before hotend 136. In such an arrangement, the distance between the filament sensor(s) 146 and the drive gear 134 needs to be precisely known in advance and used as a factor in the flow calculation, in order for the drive mechanism 132 to correctly adjust once the under- or over-dimensioned filament reaches the nozzle 138.

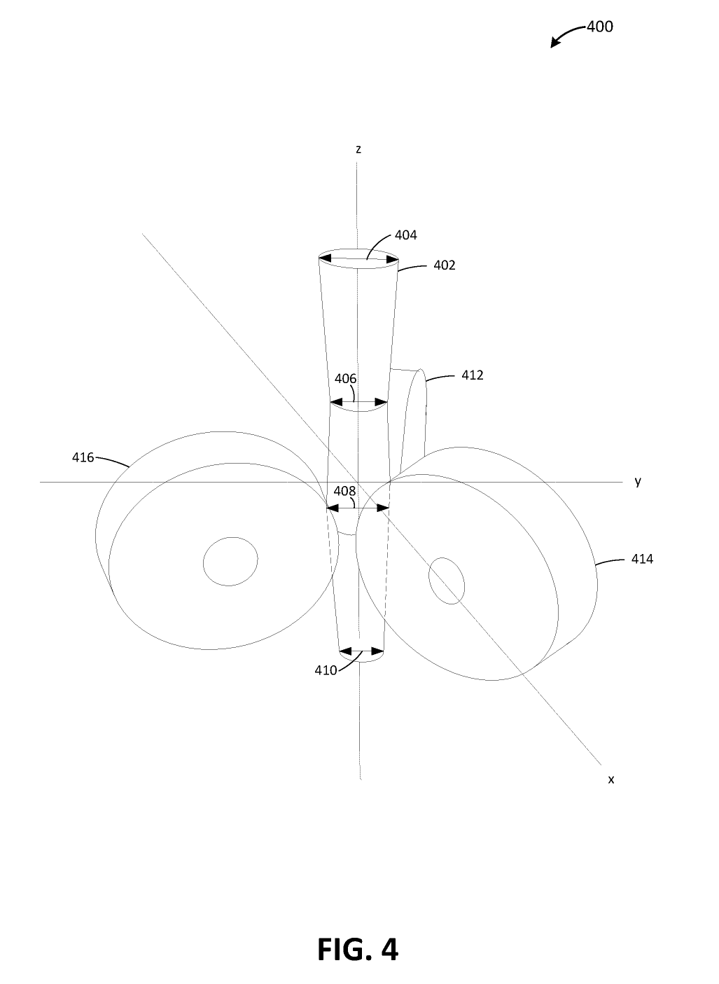

In some aspects, filament sensor(s) 146 may include mechanical sensors, such as a spring-loaded pinch-roller system with one or more angle or distance encoders that measures the gap between the pinch rollers in contact with the filament 126. An example of a three pinch-roller system will be described in greater detail below in reference to FIG. 4. One or more angle or distance encoders can also be implemented on the commonly used pressure roller that pushes the filament against the Hobbs wheel mounted to the extruder stepper motor 132. In some aspects, the sensor(s) 146 may additionally or alternatively include optical sensors, one or more a laser/sensors, eddy-current detectors, inductive sensors, and/or capacitive sensors. The choice of sensors depends on, for example the resolution and accuracy required, sensor cost, sensing speed, mass, et al. In one example, optical sensors may measure the amount of light that escapes around the filament 126 when a known level of illumination is provided from a source shining from the opposite side of the filament 126.

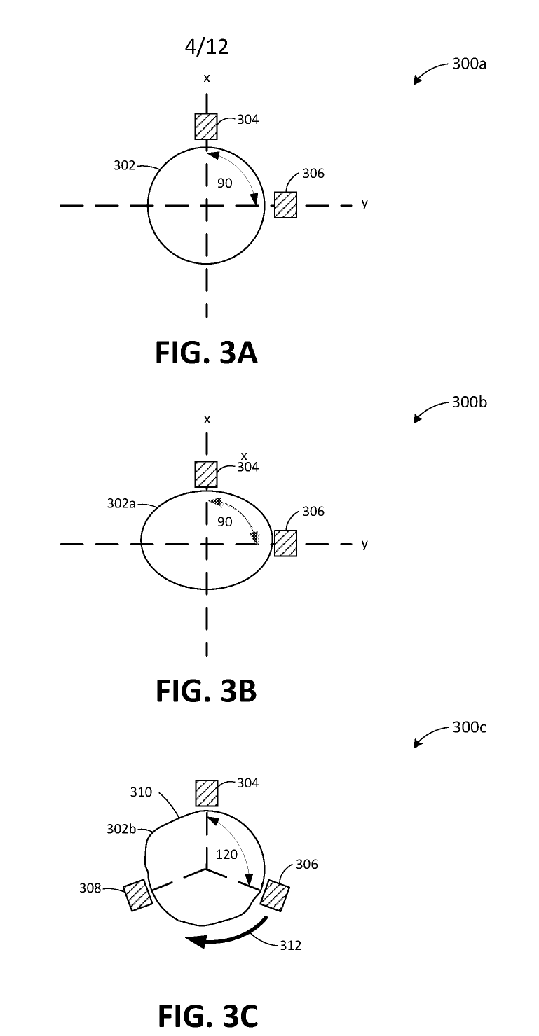

The sensors 146 may measure the diameter of the filament, for example from different angles. If the filament 126 is not perfectly round, which is generally the case, the diameter values taken from different angles will vary to some degree. These diameter values can then be combined to determine a cross-sectional area of the filament 126. In the case that the filament is not perfectly round, multiple diameter measurements may provide a more accurate cross-sectional area measurement. This may enable tuning of the drive mechanism 132 to ensure that a consistent amount of filament is delivered to the hotend 136 for extrusion. For example, the measured diameter may be used to adjust an extrusion-rate parameter (also known as “flow ratio”) to the printer controller microprocessor 11, which in turn adjusts the amount of rotation in the drive gear. Alternatively one or more sensors 146 can rotate around the axis of the filament 126 in order to take measurements from multiple points along a spiral on the outside of the filament 126 and thus compensate for situations where the filament cross-section is not consistently circular but triangular, square or any irregular shape (which is illustrated by arrow 312 illustrated in FIG. 3C).

A single sensor, such as an optical, force sensing resistor (FSR), or other typed of sensors, used in existing designs may not work well for all filament materials (e.g., transparent, semi-transparent) or filament with cross-sections that aren't perfectly circular, as described above. By utilizing more than one sensor to measure the filament cross-section, accuracy in determine the amount of filament delivered to the hotend 136 may be increased, particularly when the filament has a varying diameter and/or is not perfectly circular in cross-section. FIGS. 3A-3C depict example cross-sectional views 300a, 300b, and 300c of filaments 302 in relation to two or more displacement sensors 304, 306, and 308 that may be utilized to improve the accuracy of filament sensing.

FIG. 3A illustrates a perfectly circular filament 302 with two filament sensors 304 and 306 located approximately 90 degrees apart from each other relative to and perpendicular to the axis of the filament 302. FIG. 3B illustrates an oval-shaped filament 302a with two filament sensors 304, 306 also located approximately 90 degrees apart from each other relative to the axis of the filament 302a. In this example, if only one sensor were used, an inaccurate or less accurate filament diameter or cross-sectional area measurement could be produced. By utilizing two sensors 304, 306, the variation in x-axis versus y-axis diameter may be measured and accounted for, thus enabling a more accurate filament cross-sectional area measurement, and more accurate 3D printing. Some aspects may include the second filament sensor being oriented anywhere from 10 to 170 degrees about the center of the filament diameter relative to the orientation of the first filament sensor. FIG. 3C illustrates another example cross-section of a filament 302b having a number of irregularities 310. Filament 302b may be measured with three sensors 304, 306, and 308 positioned approximately 120 degrees apart relative to an axis of the filament 302b. This sensor configuration may provide for even more accuracy in measuring the area of a filament 302.

It should be appreciated that the above examples are only for illustrative purposes. Other numbers of sensors and/or spaced at different angular positions from each other are contemplated herein. For example, sensors may not be evenly spaced about an axis of the filament 302, for example due to space, cost, or other constraints of placement of the sensor system. In some aspects, one or more sensors may be placed in different planes relative to an axis of the filament 302, for a number of reasons. In one example, fixed guides may be interleaved between the sensors 304, 306, and/or 308, such that any deformation in the filament 302 conforms (takes the shape) of the guides. In the event the filament 302 does not conform to the guides, pressure may be applied to one or more sensors 304, 306, 308, and either a warning issued or the speed/flow at which the filament 302 is

FIG. 4 illustrates a more detailed perspective view 400 of an arrangement of three rollers 412, 414, and 416 that may be connected to displacement sensors positioned around a filament 402. The filament 402 has varying diameters 404, 406, 408, and 410. The three rollers 412, 414, and 416 may be positioned approximately 120 degrees apart in a plane perpendicular to the axis of the filament 402. Each roller 412, 414, 416 may be positioned such that it can move relative to the filament 402. In one example, each roller 412, 414, 416 may move in the x-y plane to and away from the filament 412. In other examples, the one or more rollers 412, 414, 416 may move in one or more other directions relative to the filaments 402, for example, to better detect changes in filament 402 diameter. The amount of movement of each of the rollers 412, 414, 416 may be detected, for example via mechanical, electrical, magnetic or other sensors or means. The amount of movement of each roller 412, 414, 416 may then be used to calculate an average diameter or cross-sectional area of the filament 402, to adjust the rate at which filament 402 is provided to the hotend 136 of the 3D printer 104.

In one example, one or more of rollers 412, 414, 416 may move independently of one or more other rollers, and/or may be biased to press against the filament 402. In one example, one or more of rollers 412, 414, 416 may be fixed in position, such that one or two of rollers 412, 414, 416 is moveable. One or more of rollers 412, 414, 416 may be biased via spring mechanism or other mechanism. The surface of the rollers 412, 414, 416 that contact the filament 402 may be coated or comprised of a wear resistant and/or friction-minimizing material. In another example, one or more of rollers 412, 414, 416 may be magnetically biased to move toward and/or lightly contact the filament, such that changes in the movement of roller 412, 414, and/or 416 may be detected via changes in the magnetic field imposed on one or more sensors.

In some aspects, each roller 412, 414, 416 may be part of or integrated with drive mechanism 132 described in reference to FIGS. 1 and 2. For example, roller 412 can be a drive gear, 414 can be a fixed pressure roller and 416 can be a sensor, measuring side expansion of the filament 402. In another example, roller 412 can be the drive gear and rollers 414 and 416 can be connected and act both as pressure rollers, attached to one or more displacement sensors.

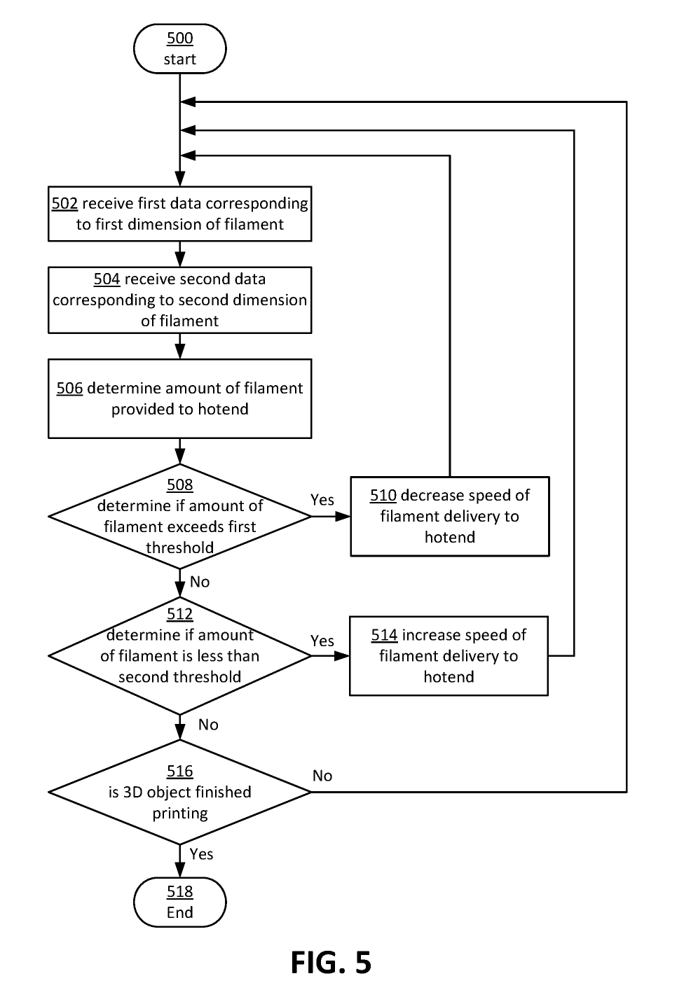

FIG. 5 illustrates an example process 500 for adjusting a speed at which filament is provided to a hot end of a 3D printer based on a measured amount of filament. Process 500 may be performed by one or more sensors, such as sensors 146, 304, 306, 308, and/or rollers 412, 414, 416 and printer controller 110 and/or slicer 165, as described above.

Process 500 may start at operation 502, where first data corresponding to a first dimension of a filament may be received, for example, by controller 110 and/or slicer 116. The first data may be generated by one or more sensors 146, 304, 306, 308, and/or rollers 412, 414, 416. Next, at operation 504, second data corresponding to second dimension of the filament may be received, for example form the same or different of sensors 146, 304, 306, 308, and/or rollers 412, 414, 416. Based on the first and second dimensional data, an amount of filament provided to the hotend 136 may be determined at operation 506. The amount may include a cross-sectional area of the filament multiplied by the speed at which the drive mechanism 132 is providing filament to hotend 136.

Process 500 may continue to operation 508, where the amount of filament provided to the hotend may be compared with a first threshold. If the amount exceeds the first threshold, the speed of the filament delivery may be decreased (e.g., via one or more instructions sent to the drive mechanism 132), at operation 510. Process 500 may then loop back to operations 502, 504, and 506 where new dimensional information may be obtained and an amount of filament delivered to the hotend determined. If, at operation 508, the amount of filament does not exceed the first threshold, process 500 may continue to operation 512, where the amount of filament may be compared to a second threshold. If the amount of filament is less than the second threshold, the speed at which filament is delivered to the hotend may be increased at operation 514. Process 500 may then loop back through operations 502, 504, 506, and 508. If, at operation 512, the amount of filament is not less than the second threshold, process 500 may continue to operation 516, where it may be determined if the 3D object is finished printing. If not, process 500 may loop back to process 502 and continue until the 3D object is determined to be finished, at which point process 500 may end at 518.

It should be appreciated that the use of two filament amount thresholds is only given by way of example, such that operations 508 and 512 may be combined in the case that more than two thresholds are utilized. In some aspects, the amount at which the speed of the filament delivery is increased or decreased at operations 514 or 510, may vary or may be changed, for example, depending on how far away the actual amount of filament differs from the first or second thresholds. In addition, there may be some cases where the required adjustment can be too far from the threshold, which may indicate a failure in the mechanism (broken sensor) or a break in the filament. In one example, such a sensor reading may be used to indicate an end of filament spool, allowing or prompting the user to pause the print, change the filament to a new spool and resume the print. In this way, the need of an extra sensor to detect when a filament spool has been expired may be eliminated, thus may save costs, reduce machine complexity, etc.

With reference again to FIG. 2A, in some aspects one or more filament drive force sensing sensors 148 may be electrically connected to drive mechanism 132, for example, to aid in optimizing the hotend 136 temperature of the 3D printer 104 for a particular filament 126. In some cases, sensor 148 may include a physical sensor apart from controller 110, or may be integrated into controller 110 or within integrated or discrete circuitry that controls the extrusion motor 132. The sensor 148 may provide current, torque or other power information drawn by or fed to the drive mechanism during extrusion of filament 126, for example, to be used to optimize the hotend 136 temperature of the 3D printer 104 for a particular filament 126.

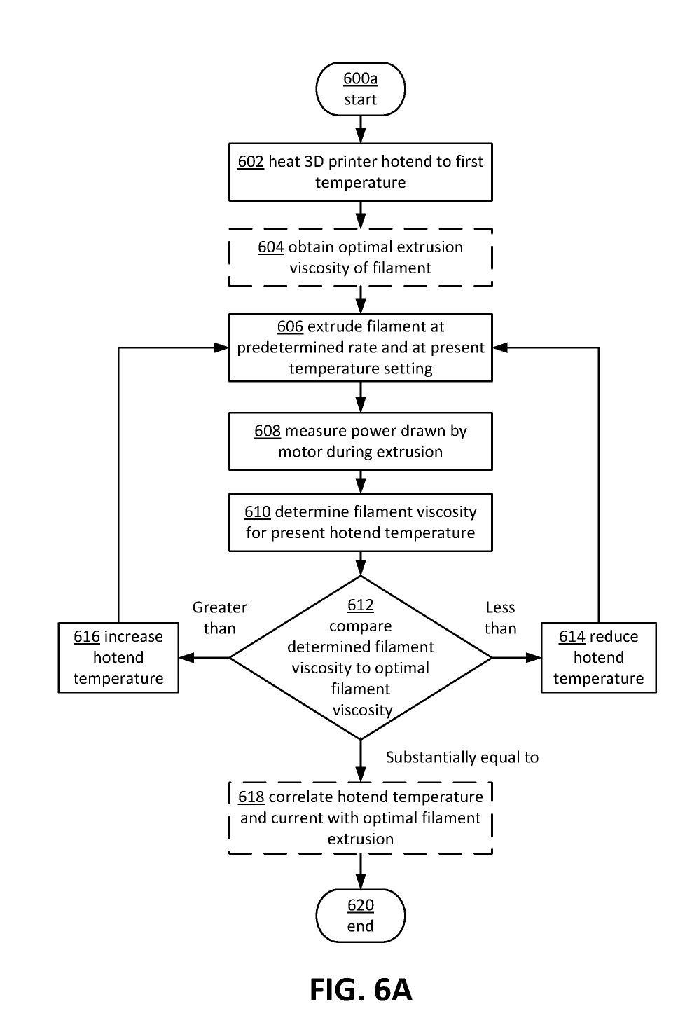

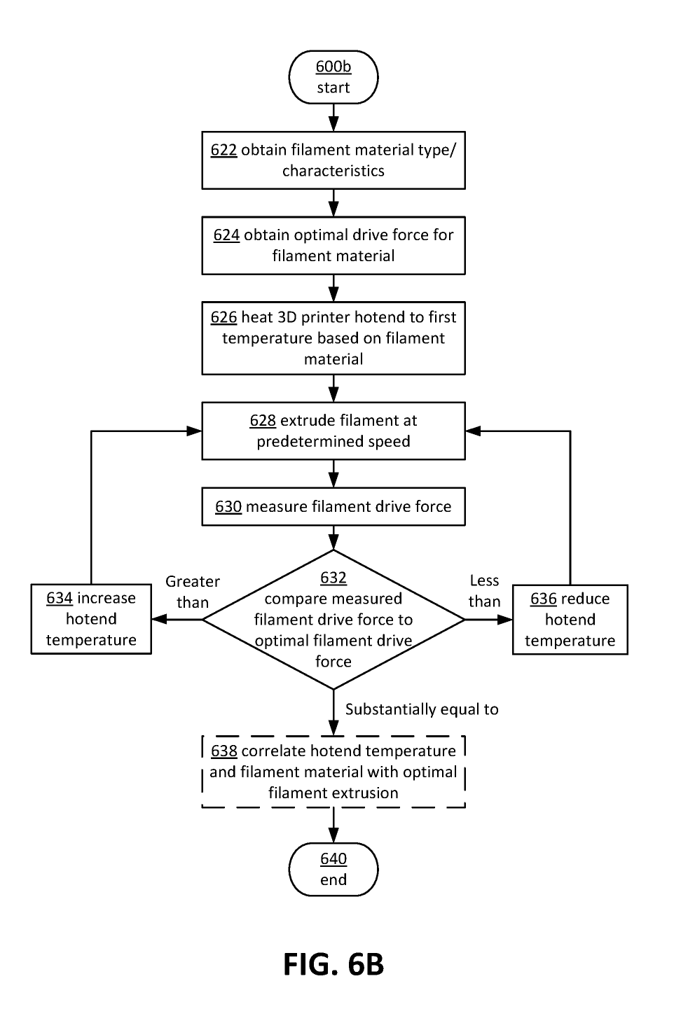

FIGS. 6A and 6B illustrate example processes 600a and 600b for calibrating a 3D printer, and more specially, a process for calibrating the temperature at which the filament is melted, based on an optimal viscosity of the specific filament used in the 3D printer at a given time. Process 600a and/or process 600b may be performed by controller 110 using integrated power sensing or remote sensor 148. In some aspects, process 600a and/or process 600b may be performed upon loading new filament 126/128 into 3D printer 104.

Process 600a may begin at operation 602, where the hotend, such as hotend 136 of 3D printer 104, may be set to a first temperature. In some aspects, operation 602 may include the controller 110 applying power to heating element 142 to raise the temperature of hotend 136 to a first temperature, for example based on a manufacturer specified melting temperature, or based on a melting temperature generally associated with the type of material (e.g., ABS, PLA) of the filament 126. Next, at operation 604, an optimal viscosity of the filament 126 may be obtained, for example, from a specification of the filament provided by the manufacturer, or it may be determined by other means. For example, the optimal viscosity may be obtained by measuring the relative force required for the manufacturer's recommended temperature and extrusion rate. If the filament acquired from a manufacturer that doesn't provide a material specification datasheet and that comprises a common material (e.g., ABS, PLA), the optimal viscosity will likely be close to that specified by a known manufacturer of a filament of the same material. It should be appreciated that operation 604 may be performed at any time during process 600, prior to operation 612. Next, at operation 606, filament 126 may be extruded through nozzle 140 when the controller 110 has regulated power to the heating element 142 to heat and maintain the hotend 136 temperature to the first temperature. Extruding filament 126 through nozzle 140 during operation 606 and during operations 608-616 may be performed with the extruder close enough to adhere to the build plate or previous extrusion layer, and in motion to deposit material strips in the x-y plane. Alternatively, extrusion during loop operations 606-616 may be performed with the extruder statically positioned well above the build plate (not in motion). Based on hotend 136 exit orifice size, the predetermined extrusion rate at operation 606, and the motor power measured at operation 608, an extrusion viscosity of the filament 126 at the present temperature setting may be determined, using the relationship between force applied to the filament by the drive mechanism 132 and the hotend 136 exit orifice size, at operation 610. In some embodiments, back EMF may be used to determine relative force. In one example, the Trinamic 5130A chip uses a fixed target current and allows the back EMF, proportional to motor power draw and torque, to be read for force sensing. Other embodiments may implement various means of sensing force that can include, for example, measuring motor current, voltage, as well as sensing force with piezoelectric sensors, force sensitive resistors (FSR), etc. Operation 610 may include, for example, taking measurements of filament driving force vs. hotend temperature, then picking the optimal viscosity based on an area of the curve where the rate of decrease in force with increasing temperature begins to diminish.

Next, at operation 612, the obtained filament viscosity may be compared to the optimal viscosity. If the obtained filament viscosity is less than the optimal value, the hotend temperature may be decreased at operation 614, thereby increasing the filament viscosity. If the obtained filament viscosity is greater than the optimal value, the hotend temperature may be increased at operation 616, thereby decreasing the filament viscosity. In either case, the modified temperature may be recorded and processed by controller 110 to raise or lower the hotend 136 temperature by one or more degrees, and the process may return to operation 606 and subsequent operations 608-616. When, at operation 612, the obtained viscosity is substantially equal to the optimal filament viscosity, optionally, the hotend temperature and drive force may be correlated/stored with settings for optimal extrusion of the particular filament 126, and process 600a may end at 620.

In some aspects, operations 606-616 may be performed repeatedly until the optimal filament viscosity is achieved, or close thereto. In some aspects, the rate at which the hotend temperature is decreased at operation 614 or increased at operation 616 may change and/or be determined according to the magnitude of the difference between the determined value 610 and the obtained optimal value. Further, the extrusion occurring in operations 606-616 may be a continuous process or may be interrupted during temperature changes or for other purposes. Continuous filament extrusion at operations 606-616 while making linear or nonlinear incremental temperature changes at operations 614 or 616 enables continuous, repeated motor force measurements 608 taken as a function of temperature. In some aspects, a nonlinear temperature change profile may be used that begins with larger temperature change and increments at 614 or 616 and tapers to smaller increments as force measurements 608 in this process indicate that the determined viscosity 610 is nearing optimal viscosity. This may result in arriving sooner to the point where the measured viscosity is substantially equal to the optimal viscosity without overshooting the optimal value.

An alternative method 600b for calibrating the hotend 136 temperature for a filament 126 material that doesn't require obtaining an optimal filament viscosity for extrusion as in 604 for comparison at step 612, is illustrated in FIG. 6B. Process 600b relies on obtaining an optimal drive force for a filament material that produces a satisfactory filament viscosity for extrusion. Since the filament drive force required to extrude material at a given extrusion speed, temperature, and hotend exit orifice dimension is proportionate to the filament material viscosity, and given that the hotend exit orifice dimension is a constant, all that is necessary is to determine a temperature that results in an optimal filament drive force. The drive force may increase as filament temperature decreases, or as extrusion rate increases. For a given material, an optimal temperature of the extruded material may be assumed at the time when the material touches the previous layer. Rather than measure this temperature directly, an indirect measurement of viscosity may be determined based on the relative force required to extrude. This force may depend on the nozzle diameter, with a higher force required for a smaller orifice. Artifacts such as stringing may result if the temperature is too high, and if the temperature is too low then too much force may be required. A balance may be achieved between reducing force and reducing stringing (and drooping for overhangs).Optimal drive force data for a given filament material (e.g., PLA, ABS) would ideally be provided by the printer manufacturer, for example, stored in the printer controller 110 firmware.

Process 600b for automatically calibrating hotend 136 temperature for a given filament may begin at operation 622, where filament material type and/or other characteristics may be obtained. In one example, when a new spool of filament 126 has been installed on the 3D printer 104, the user may indicate to the controller 110 the type of filament material installed and the extrusion temperature recommended by the manufacturer (typically printed on a label affixed to the filament spool) or by a known average extrusion temperature for the material installed. In some cases, this information may be in part or completely automatically detected. Upon receiving, obtaining, or detecting this information concurrently with or after operation 622, process 600b may also include operation 624, in which an optimal drive force for a specific filament material and/or manufacturer may be obtained. Next or concurrently with operations 622 and/or 624, process 600b may also include operation 626, in which the controller 110 may apply power to heat the hotend 136 to the recommended temperature for the filament material. Next, the calibration process 600b may include extruding the material at a predetermined speed at operation 628. During extrusion at operation 628, the filament drive force may be measured, such as continuously, or periodically, at operation 630, and the measured filament drive force may be compared to the optimal filament drive force, at operation 632. If the drive force is greater than the optimal drive force, process 600b may proceed to operation 634, in which the hotend temperature may be increased. If the drive force is less than the optimal drive force, process 600b may proceed to operation 636, in which the hotend temperature may be reduced. In either case, the filament may continue to be extruded, the filament drive force measured, and then compared to the optimal drive force at operations 628-632 and/or operations 634 and 636 until the measured drive force is substantially equally to the optimal drive force. If this is the case, process 600b may proceed to operation 638, where the hotend temperature and the filament type/material may be correlated with optimal filament extrusion, at which point process 600b may end.

As described above in relation to process 600a of FIG. 6A, similar optimizations of process 600b may similarly be implemented.

In one aspect, a method for automatic calibration of an extruder hot-end temperature to optimize a melted material viscosity for a 3D printing device may include extruding, at an extrusion rate and a hot-end temperature, by a motor of a 3D printer a material filament into a hot end nozzle that melts the material before being forced out of an orifice of the hot-end nozzle. The method may further include sensing filament drive force by, but not limited to measuring back EMF, motor drive current, motor drive voltage, receiving data from piezoelectric sensors, force sensing resistors, or other means of sensing force while the extruding is performed. A viscosity of the melted material may be determined based on sensing the filament drive force and at least one of the extrusion rate or a diameter of the orifice. The hot-end temperature may be increased or decreased if the determined viscosity is respectively less than or greater than a predetermined optimal viscosity. When the determined viscosity is substantially equal to the predetermined optimal viscosity, the hot-end temperature value may be stored, for example, for future use/calibration. This approach and the other approached described above may represent a significant improvement over the load-cell approach used by current 3D printing mechanisms, as the described techniques require no extra parts and eliminate the attendant weight and additional signal conditioning electronics or inputs to the printer controller. In addition, as many extruder motor drivers are capable of sensing and reporting motor or torque to the controller via an analog input, the described techniques may be easily implemented in existing devices.

Other approaches to measuring the filament drive force besides sensing motor drive current or torque may be effective in various extruder system designs. Extruder designs generally fall into two configurations—1) the filament drive motor is mounted together with the hotend on the movable extruder plate, and 2) the filament drive motor is mounted remotely with the filament supported in a flexible sheath that is fixed on one end at the motor drive output and on the other end at the hotend input orifice. Configuration 1 is by far the most popular while configuration 2, generally referred to as the “Bowden Extruder”, has the advantage of reduced mass on the movable extruder plate but may not provide accurate control of filament drive and retraction due in large part to filament “backlash” in the flexible filament guide sheath. Previous known attempts at measuring a filament drive force were made with a Bowden extruder configuration using a cantilevered load cell attached to a frame on one end, and with the filament drive motor mounted on the other end, to sense the load cell stress during extrusion. The optimal place to sense filament drive force is at the hotend itself where the material extrusion is taking place. Load cells are generally not available for limited space installations, must flex to sense force, are relatively expensive, and as such are not well suited for sensing the filament drive forces at the hotend mount. However piezoelectric ceramic discs are available in washer shapes with various outside/inside diameter and thickness configurations that can be easily fitted to the cylindrical shape of the upper end of an extruder hotend. Most commercially available hotends are removably fixed to a mounting plate and attached to the moveable extruder plate configured to receive filament in the top orifice, which is driven directly or remotely by a filament drive motor.

As depicted in FIG. 2B, one or more piezoelectric ceramic discs or other piezoelectric sensors 210 can be configured to fit on top or underneath hotend mounting plate 212, in such a manner that filament drive forces during extrusion/retraction apply pressure to one side or the other of a piezoelectric sensor 210. The piezoelectric sensor(s) 210 may generate a transient voltage of one polarity or the other in response to changes in force applied to them. Force sensing resistors (FSR) or other pressure sensitive sensors may also be used in addition to or in place of the piezoelectric sensor(s) 210.

As depicted in FIG. 2B, the piezoelectric sensor(s) 210 may be placed around the top collar of the hotend below the input orifice into which the filament 126 is driven, and held in place by one or more spacers/washers, or hotend caps 214 and a mounting bracket 216, which may be fixed, via bolts, screws, or other fasteners, adhesive, etc., to the top plate 212 of hotend 136. The spacers 214 and/or mounting bracket 216 may be located on the far side of the plate 212 from where the sensor(s) 210 are located (e.g., either above or below plate 212. In other aspects the sensor(s) may be located anywhere at the top of the hotend above its cooling section 218, where it is affixed to the mounting plate such that that the force of the filament 126 being driven into the hotend input orifice is communicated to sensor(s) 210 so that the force is sensed. Similarly, a sensor 210 may also be mounted under hotend mounting plate 212 such that the reverse force of the hotend produced by filament 126 retraction while printing is communicated to the sensor 210 for measurement. In some aspects hotend 136 may include one or more cooling fins or other cooling structures 218, for example, to better control the temperature of the filament 126 and the location at which the temperature of the filament 126 changes.

In some aspects the amount and consistency of filament extruded by a 3D printer depends on a number of factors, such as:

Viscosity of the melted filament

Shape, length, and temperature profile of the heat break and melt zone

Size and shape of the nozzle

Characteristics of the filament

Force applied to the filament being driven into the hot end

Temperature of the heat block at the thermistor

Thermal conductivity of the heat block, nozzle, heat zone, and the heat break

The friction in the hotend may be greatest in the area where the filament begins to soften and melt. Soon after it begins to soften, the filament will begin to expand to the outer walls of the chamber and be a source of friction. This friction is higher at lower temperatures. In other words, the friction of the melting filament decreases as the temperature increases due to decrease in viscosity. Typical hotends are carefully designed to minimize the length of the melt zone in order to minimize the total force required to extrude filament.

In addition to the above consideration, typically the filament is driven into the hotend using an extruder driven by a stepper motor. These stepper motors have their own characteristics. In general, the current/power provided to the stepper motors is set high enough so the filament can be pushed through the extruder at a specific, commanded rate, regardless of the force required to drive the filament. In other words, the torque available for each step well exceeds the torque required in order to force the filament through the hotend. Motor drive current, voltage, or back electromotive force (back EMF) may be used to infer the actual torque being provided to drive the filament through the hotend.

In one example, when printing small layers, quite often the print speed (and therefore extrusion rate) is slowed down considerably to give the layer enough time to cool before printing the next layer. As an example, the minimum layer time may be set to 10 seconds. Therefore, if there isn't much to print on a layer, the X/Y movement speed while extruding might drop to 10mm/second, whereas it might be 50 mm/second for layers that take a long time to extrude. When printing at such a slow speed, it may be desirable to reduce the viscosity of the melted filament in order to keep the optimal behavior of the filament. What happens normally is that the filament takes some time to absorb the heat from the hotend. If extruding is performed quickly, the plastic may not rise to the full temperature before being extruded, resulting in a higher viscosity. If, on the other hand, the filament is in the heated area for a longer duration, it will reach a higher temperature before being extruded, and thus have a lower viscosity. Having a consistent viscosity may directly impact print quality.

At one extreme, if the hotend has heated up and it remains in that state for some period of time with little or no extrusion activity, the melted filament has much lower viscosity than normal, and as such, has more of a liquid character. This illustrates that, in the normal case, the filament doesn't have time to heat up to full temperature before being pushed out the nozzle. That is why it's important to have knowledge of the characteristics of the melted filament at different heat block temperatures and extrusion rates.

By plotting the actual characteristics and then extrapolating, it is possible to dynamically adjust the heat block temperature to maintain optimal filament viscosity at varying extrusion rates. By using the actual measured temperature of the heat block, e.g., by using data directly from the hotend temperature sensor, rather than data indicating the commanded temperature, together with the extrapolated force required to extrude at a specific rate, it is possible to adjust the feed (e.g., extrusion) rate or temperature to maintain the optimal viscosity of the melted filament.

In order to account for these factors, improvements can be made to the temperature measuring process, whereby the 3D print instructions (e.g., G-code) may be modified based on the more accurate measurements. First, the measurement phase may be modified by creating a profile of force required for different combinations of temperature and feed or extrusion rate. The amount of time it takes to change the temperature between the different measured temperatures may also be determined. Next, the expected force required to extrude the filament may be extrapolated from measured combinations of temperature/feed rate. Variations in the force (for a given requested feed rate, from the G-code) may be used to adjust the actual feed rate. The commanded temperature may then be dynamically adjusted so the actual temperature will reach a target at approximately the right time to keep the viscosity relatively consistent during the build.

To achieve a consistent extrusion rate, we can measure the actual force required to extrude filament that takes several factors into consideration:

1. Commanded temperature of the hot end

2. Commanded extrusion rate

The average force required to extrude at a temperature and extrusion rate may be determined by measuring the force for multiple combinations of 1 and 2 above, and generating a table or other data structure that may be augmented by extrapolation (linear, curved, best fit, etc.) to calculate a target temperature and force for a specified extrusion rate.

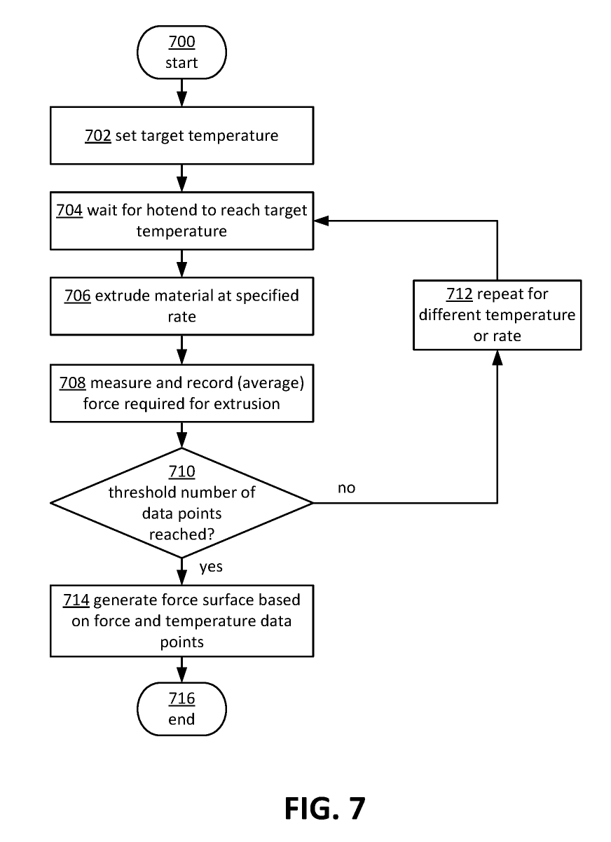

A “force surface” is the representation of the measured force for different combinations of hot-end temperature and extrusion rate. FIG. 7 illustrates an example process of measuring a force surface. Process 700 may begin at operation 702, where a target temperature may be set, and the hotend warms up to the set temperature, at operation 704. Next, at operation 706, a given material may be extruded at a specified extrusion rate. The force required to extrude the material may be measured and/or recorded, at operation 708. In some aspects the measured force may be an average force value, over a configurable of default period of extruding. In some aspects a number of data points—each including a force value associated with a temperature value—may be configurable. In some aspects as few as two data points may be used. In other cases three or more data points may be used, depending on how precise a user desires the determined force surface to be, how much time is available for the calibration process, etc. Accordingly, at operation 710, it may be determined if a threshold number of data points has been recorded. If not, process 700 may proceed to operation 712, where another temperature or extrusion rate may be selected and used to perform operations 704, 706, and 708. Upon recording the threshold number of data points, process 700 may proceed from operation 710 to operation 714, where a force surface may be generated from the temperature and force data points.

In one aspect, there might be four measurements, with each combination of minimum and maximum temperature, along with each combination of minimum and maximum feed or extrusion rate that will be used when printing. In another aspect, the measurements might include the four “corners” for the force surface, along with a point in the middle (middle temperature and middle feed-rate). Depending on the amount of variation between measured points on the surface, it might warrant taking additional measurements to provide a better sample of the actual force surface. This force surface might be measured on demand, such as for initial calibration of a 3D printer, or when changing filaments, for example.

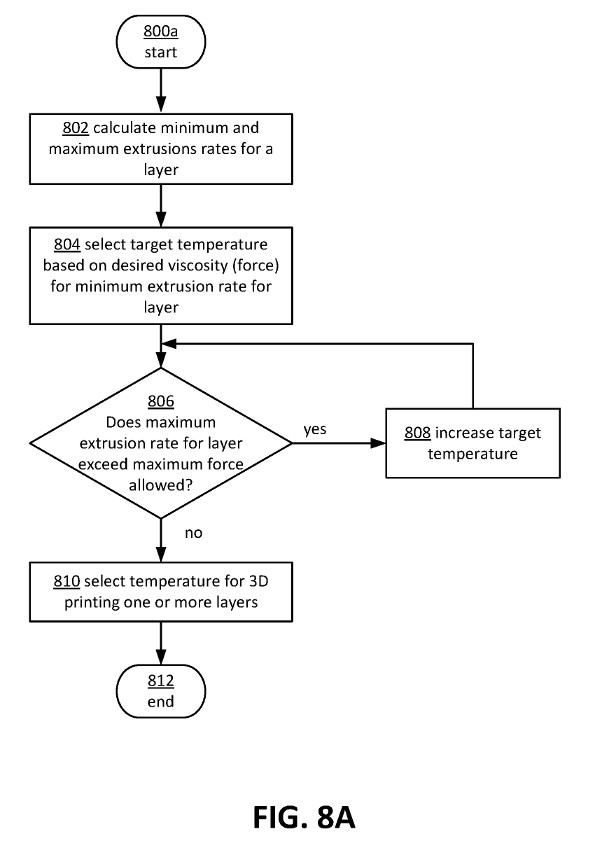

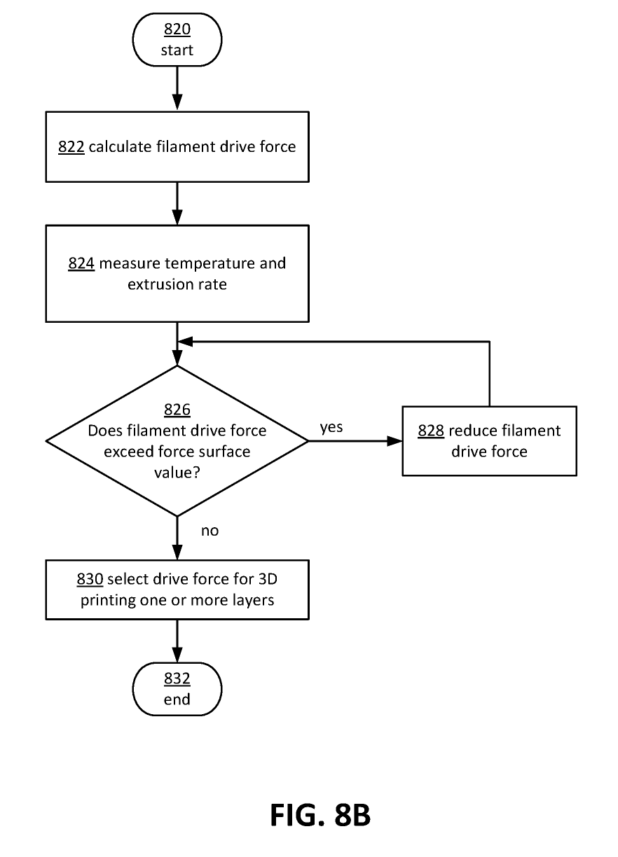

In some aspects, the force surface can be used to calculate a target temperature for future layers to be printed. As it generally takes some time for the extruder temperature to change, the temperature of the hotend cannot be changed quickly enough typically to use different temperatures for outer perimeters versus the inside infill of a given 3D print layer. However, the force surface may be used to calculate an overall target temperature for a layer or set of layers. FIG. 8A illustrates an example process 800a for determining a target temperature for a given layer or layers to be generated by a 3D printing device, based on minimum and maximum extrusion rates. In some aspects slower extrusion rates typically used for perimeters (therefore the visible part), may be preferable.

Process 800a may begin at operation 802, in which the minimum and maximum extrusion rates required or desired for a layer or layers may be calculated or determined. At operation 804, a target temperature may be selected that has the desired viscosity (force) for the minimum extrusion rate required for the layer. Next, at operation 806, it may be determined if the maximum extrusion rate required for a layer exceeds the maximum force allowed, for example, for a given printer/extruder/hotend relative to a filament material. If the determination at operation 806 is positive, the target temperature may be increased, at operation 808, and process 800 may loop back to operation 806. Process 800 may continue to loop through operations 806 and 808 until the maximum extrusion rate for the layer does not exceed the maximum force allowed, at which point the selected/adjusted temperature may be set or associated with the layer or layers, at operator 810.

In some aspects the temperature selected at operation 804 may be based on or determined from the force surface determined according to process 700. In some aspects the target temperature can be calculated, as described briefly above, with two input values: desired extrusion force and maximum allowed extrusion force. Given an extrusion force, extrapolation may be used according to various techniques, such as straight line, spline curves, or Bezier curves, for example, to calculate the temperature. An example algorithm, using straight-line extrapolation, is provided below, where F(t,r) is the measured force at temperature t and extrusion rate r, where there are four points measured are (t1,r1),(t1,r2),(t2,r1),(t2,r2), where the target extrusion rate is r, and the calculated target temperature is t:
1. Use linear extrapolation to calculate F(t1,r) using the values F(t1,r1) and F(t1,r2)
2. Use linear extrapolation to calculate F(t2,r) using the values F(t2,r1) and F(t2,r2)
3. Use linear extrapolation to calculate the target temperature using the values of F(t1,r) and F(t2,r) calculated in steps 1 and 2 above.

The measurement and capturing of force data may be performed in the firmware (e.g., of printer controller 110), or with a combination of firmware and control software, which maybe executing on a client device 102. The choice of target temperature may be performed in the slicer 116, assuming it has access to the force surface measured by the 3D printer 104. Alternatively, the calculation of target temperature could be done by the firmware 110 in the 3D printer rather than the slicer 116. Alternatively, it could be done in the control software of client device 102 that sends the output of the slicer 116 to the 3D printer 104. Some slicers output G-code or other command codes either in memory or as an external file. In this case, other code, either in the same program or another program, may send this g-code to the print controller that is controlling the printer (hot end temperature, stepper motors, etc.).

When the force required to extrude the filament through the hotend becomes too high there is an increased chance that the filament will jam in the hotend, creating a condition where no amount of drive force will result in filament being extruded from the hotend. Jamming can be caused by printing too slowly for a given temperature, which can cause the filament to soften and swell above the heat break, where the friction will be quite high. Jamming can also occur when printing at a high extrusion rate at a temperature too low to maintain the melted filament viscosity sufficiently low, and the drive force increases to the point where the drive wheel begins slipping on the filament—creating a stall condition. In a stalled filament condition, extrusion slows or stops altogether but the drive motor and printer continue as long as the stall remains undetected. To protect the hotend and reduce the severity of a jam, detecting the conditions indicative of the early stages of a jam opens the possibility of preventing or at least minimizing the severity of a jam. One approach to detecting the onset of a filament jam is to measure the force required to drive the filament through the hotend and determining when the drive force exceeds a specified value such as a maximum allowed extrusion force. In one aspect, monitoring the extruder motor back EMF may be used to detect the filament drive force threshold signaling the potential onset of a hotend filament jam. Once a jam, or an imminent jam is detected, there are different options for dealing with the situation. One option would be to suspend the print by turning off the hotend heater and raising the hotend above the part being printed. This functionality can be implemented in the printer's firmware 110, in the control software of device 102, or in another device to which the force sensor is connected or attached. In some embodiments, a filament speed sensor can be implemented that is configured to measure the filament speed independently of the commanded drive motor speed. This will allow detection of slipping so that appropriate actions can be taken. The filament speed sensor can be integrated into the pressure wheel that pushes the filament onto the drive motor/Hobbs wheel discussed above. The sensor can take the form of an optical interrupter, an optical encoder, a laser reflecting off of a speckled surface, or other rotation sensor.

While filament jams may be detected to stop a print operation, it is preferable to detect conditions leading up to the possible onset of a hotend filament jam or stall and take action to prevent it from occurring. Detecting conditions presaging the onset of a potential jam condition may be facilitated by using the force surface of temperature vs. extrusion rate determined according to process 700. Detecting such conditions may be accomplished by periodically measuring the extrusion rate and data from the temperature sensor attached to the hotend, and comparing the filament drive force to the force surface table value at the measured temperature and extrusion rate. If the measured drive force exceeds the surface table force value by a predetermined amount (e.g., 10%), then actions may be taken to potentially prevent the onset of a hotend filament jam. Actions that may reduce the chance of advancing to the jam onset condition may include, but are not limited to changing the temperature and/or extrusion rate to a lower force surface value. To avoid disfiguring the object being printed, the extrusion may be halted, the extrusion point coordinates may be saved, and the extruder may be temporarily moved away from the object while the actions taken to avoid the jam onset condition may be made and if successful, the extruder may be repositioned to the exact location where printing the object was interrupted, and printing may be resumed. If the actions taken are not successful, the user may be notified of the issue and user intervention may result in repairing the extruder or switching to an alternate extruder that may be returned to the stored coordinates to resume printing the object. Another option would be to increase the extrusion rate if the extrusion rate is particularly slow (such as very slow layers). Or if the printing is not particularly slow (such as normal layers), increase the target temperature, and/or reduce the hotend cooling mechanism effect. FIG. 8B illustrates an example process 820 for detecting a filament drive force exceeding a force surface value at a measured temperature and extrusion rate, for example, during extrusion.

Process 820 may begin at operation 822, in which the filament drive force required or desired for a layer or layers may be calculated or determined. At operation 824, a temperature and extrusion rate may be selected or determined as required for the layer. Next, at operation 826, it may be determined if the filament drive force required for the layer or layers exceeds the force surface value allowed, for example, for the measured temperature and extrusion rate. If the determination at operation 826 is positive, the filament drive force may be decreased at operation 828 by, for example, changing the hotend temperature and/or extrusion rate to a lower force surface value, at which point, process 820 may loop back to operation 826. Process 820 may continue to loop through operations 826 and 828 until the filament drive force for the layer or layers does not exceed the force surface value allowed, at which point the selected/adjusted force surface value may be set or associated with the layer or layers, at operation 830.

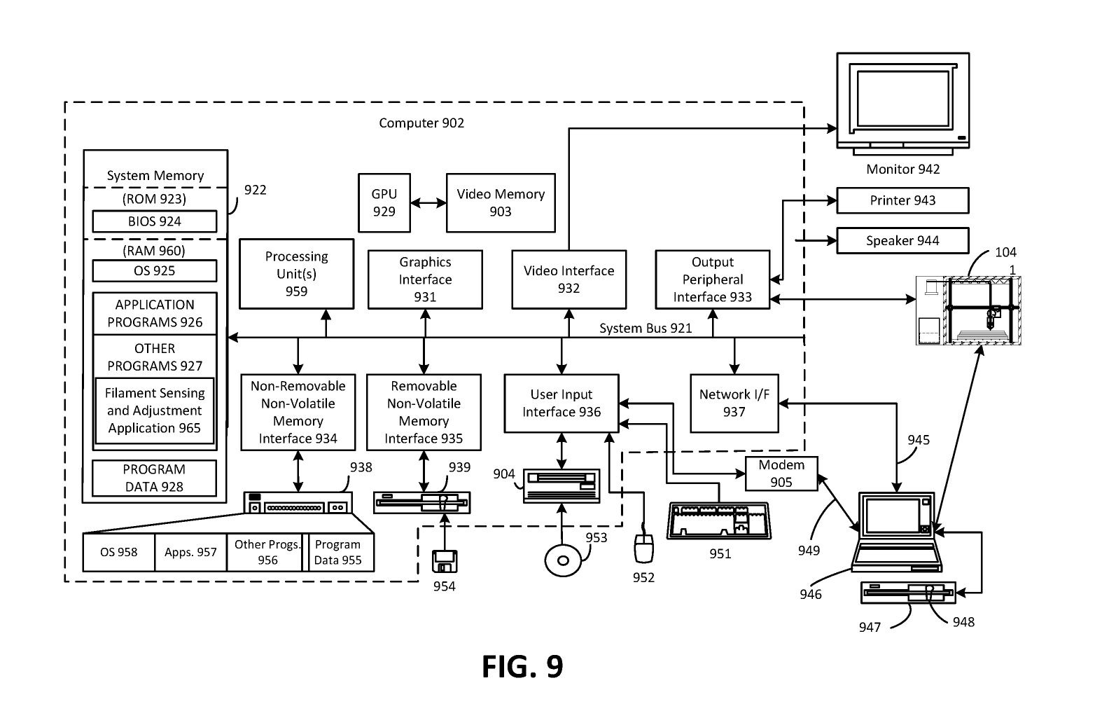

The filament measurement and speed adjustment techniques, and/or the filament extrusion viscosity/temperature calibration as described above, and/or the slicer/driver 165 and any associated user interfaces may be implemented on one or more computing devices or environments, as described below. FIG. 9 depicts an example general purpose computing environment, for example, that may include computing device 110, in which in which some of the techniques described herein may be embodied. The computing system environment 902 is only one example of a suitable computing environment and is not intended to suggest any limitation as to the scope of use or functionality of the presently disclosed subject matter. Neither should the computing environment 902 be interpreted as having any dependency or requirement relating to any one or combination of components illustrated in the example operating environment 902. In some embodiments the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computer 902, which may include any of a mobile device or smart phone, tablet, laptop, desktop computer, or collection of networked devices, cloud computing resources, etc., typically includes a variety of computer-readable media. Computer-readable media can be any available media that can be accessed by computer 902 and includes both volatile and nonvolatile media, removable and non-removable media. The system memory 922 includes computer-readable storage media in the form of volatile and/or nonvolatile memory such as read only memory (ROM) 923 and random access memory (RAM) 960. A basic input/output system 924 (BIOS), containing the basic routines that help to transfer information between elements within computer 902, such as during start-up, is typically stored in ROM 923. RAM 960 typically contains data and/or program modules that are immediately accessible to and/or presently being operated on by processing unit 959. By way of example, and not limitation, FIG. 9 illustrates operating system 925, application programs 926, other program modules 927 including a filament sensing and adjustment application 965, and program data 928.

The computer 902 may also include other removable/non-removable, volatile/nonvolatile computer storage media. By way of example only, FIG. 9 illustrates a hard disk drive 938 that reads from or writes to non-removable, nonvolatile magnetic media, a magnetic disk drive 939 that reads from or writes to a removable, nonvolatile magnetic disk 954, and an optical disk drive 904 that reads from or writes to a removable, nonvolatile optical disk 953 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 938 is typically connected to the system bus 921 through a non-removable memory interface such as interface 934, and magnetic disk drive 939 and optical disk drive 904 are typically connected to the system bus 921 by a removable memory interface, such as interface 935 or 936.

The drives and their associated computer storage media discussed above and illustrated in FIG. 9, provide storage of computer-readable instructions, data structures, program modules and other data for the computer 902. In FIG. 9, for example, hard disk drive 938 is illustrated as storing operating system 958, application programs 957, other program modules 956, and program data 955. Note that these components can either be the same as or different from operating system 925, application programs 926, other program modules 927, and program data 928. Operating system 958, application programs 957, other program modules 956, and program data 955 are given different numbers here to illustrate that, at a minimum, they are different copies. A user may enter commands and information into the computer 902 through input devices such as a keyboard 951 and pointing device 952, commonly referred to as a mouse, trackball or touch pad. Other input devices (not shown) may include a microphone, joystick, game pad, satellite dish, scanner, retinal scanner, or the like. These and other input devices are often connected to the processing unit 959 through a user input interface 936 that is coupled to the system bus 921, but may be connected by other interface and bus structures, such as a parallel port, game port or a universal serial bus (USB). A monitor 942 or other type of display device is also connected to the system bus 921 via an interface, such as a video interface 932. In addition to the monitor, computers may also include other peripheral output devices such as speakers 944 and printer 943, such as a 3D printer 104 and sensors 304, 306, 308, rollers 412, 414, 416, and/or sensor 148, which may be connected through an output peripheral interface 933.

The computer 902 may operate in a networked environment using logical connections to one or more remote computers, such as a remote computer 946. The remote computer 946 may be a personal computer, a server, a router, a network PC, a peer device or other common network node, and typically includes many or all of the elements described above relative to the computer 902, although only a memory storage device 947 has been illustrated in FIG. 9. The logical connections depicted in FIG. 9 include a local area network (LAN) 945 and a wide area network (WAN) 949, but may also include other networks. Such networking environments are commonplace in offices, enterprise-wide computer networks, intranets, the Internet, and cloud computing resources.

When used in a LAN networking environment, the computer 902 is connected to the LAN 945 through a network interface or adapter 937. When used in a WAN networking environment, the computer 902 typically includes a modem 905 or other means for establishing communications over the WAN 949, such as the Internet. The modem 905, which may be internal or external, may be connected to the system bus 921 via the user input interface 936, or other appropriate mechanism. In a networked environment, program modules depicted relative to the computer 902, or portions thereof, may be stored in the remote memory storage device. By way of example, and not limitation, FIG. 9 illustrates remote application programs 948 as residing on memory device 947. It will be appreciated that the network connections shown are example and other means of establishing a communications link between the computers may be used.

In some aspects, other programs 927 may include a filament sensing and adjustment application 965 that includes the functionality as described above, such as in or associated with one or more sensors 146, 304, 306, 308, and/or rollers 412, 414, 416, sensor 148, printer controller 110, and/or slicer 165, as described above. In some cases, the filament sensing and adjustment application 965, sensors 146, 304, 306, 308, rollers 412, 414, 416, sensor 148, and/or controller 110/slicer 116 may execute some or all operations of processes 500 and/or 600. In some aspects, the filament sensing and adjustment application 965/controller 110/slicer 116 may communicate with 3D printer 104 to produce a physical 3D object, as described above.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage. The various features and processes described above may be used independently of one another, or may be combined in various ways. All possible combinations and subcombinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. For purposes of this specification and the claims, the phrase “computer-readable storage medium” and variations thereof, does not include waves, signals, and/or other transitory and/or intangible communication media. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present disclosure may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A three-dimensional (3D) printing system comprising:
an extruder assembly comprising a hot-end;
a processor communicatively coupled to the extruder assembly; and
a memory communicatively coupled to the processor, storing instructions that when executed by the processor, cause the 3D printing system to perform the following operations:
receive first data, the first data corresponding to at least a first dimension of a filament extrudable by the 3D printing system;
receive second data, the second data corresponding to at least a second dimension of the filament extrudable by the 3D printing system;
determine an amount of the filament provided to the hot-end based on at least the first data and the second data; and
generate a 3D object, wherein generating the 3D object further comprises:
adjusting a speed at which the filament is provided to the hot-end based on the determined amount of the filament provided to the hot-end to generate the 3D object.

2. The 3D printing system of claim 1, further comprising a first sensor and a second sensor, wherein the first data is received from the first sensor and the second data is received from the second sensor.

3. The 3D printing system of claim 2, wherein the first sensor comprises a first optical sensor and the second sensor comprises a second optical sensor.

4. The 3D printing system of claim 2, wherein at least one of the first sensor or the second sensor comprises an angle or distance encoder configured to measure a gap between at least one rolling or sliding surface in opposition to another rolling or sliding surface, and wherein the rolling or sliding surface and the another rolling or sliding surface are configured to maintain continuous contact with the filament.

5. The 3D printing system of claim 2, wherein at least one of the first sensor or the second sensor comprise a laser, an eddy-current detector, an inductive sensor, or a capacitive sensor.

6. A method performed by a three-dimensional (3D) printing device for improving dimensional accuracy in generating a 3D object, the method comprising:
receiving first data, the first data corresponding to at least a first dimension of a filament extrudable by the 3D printing device;
receiving second data, the second data corresponding to at least a second dimension of the filament extrudable by the 3D printing device;
determining an amount of the filament provided to a hot-end of the 3D printing device based on at least the first data and the second data; and
during generation of the 3D object, adjusting a speed at which the filament is provided to the hot-end based on the determined amount of the filament provided to the hot-end to generate the 3D object.

7. The method of claim 6, wherein the first data is received from a first sensor and the second data is received from a second sensor.

8. The method of claim 7, wherein the first sensor comprises a first optical sensor and the second sensor comprises a second optical sensor.

9. The method of claim 8, wherein the first optical sensor is oriented substantially between the angles of 10 and 170 degrees about a center of the filament relative to the second optical sensor.

10. The method of claim 8, wherein the first optical sensor or the second optical sensor comprises an illumination source substantially between a wavelength of 100 micrometers to 100 nanometers.

11. The method of claim 6, wherein adjusting the speed at which the filament is provided to the hot-end comprises modifying one or more signals communicated to an extruder feeding the filament into the hot-end.

12. The method of claim 6, further comprising:
detecting an absence of the filament based at least on the first data or the second data; and
suspending generating the 3D object based on the detected absence of the filament.

13. The method of claim 6, wherein adjusting the speed at which the filament is provided to the hot-end is performed in real-time or near-real time.

14. The method of claim 7, wherein at least one of the first sensor or the second sensor comprises an angle or distance encoder configured to measure a gap between at least one rolling or sliding surface in opposition to another rolling or sliding surface, and wherein the rolling or sliding surface and the another rolling or sliding surface are configured to maintain continuous contact with the filament.

15. The method of claim 7, wherein at least one of the first sensor or the second sensor comprise a laser, an eddy-current detector, an inductive sensor, or a capacitive sensor.

16. The method of claim 6, wherein the first dimension comprises a first diameter, the second dimension comprises a second diameter of the filament, and the amount of filament comprises a cross-sectional area of the filament.

17. A computer-readable storage medium having stored thereon instructions that, upon execution by at least one processor, cause the at least one processor to perform operations for improving dimensional accuracy in generating a three dimensional (3D) object, the operations comprising:
receiving first data, the first data corresponding to at least a first dimension of a filament extrudable by a 3D printer;
receiving second data, the second data corresponding to at least a second dimension of the filament extrudable by the 3D printer;
determining an amount of the filament provided to a hot-end of the 3D printer based on at least the first data and the second data; and
during generation of the 3D object, adjusting a speed at which the filament is provided to the hot-end based on the determined amount of the filament provided to the hot-end to generate the 3D object.

18. The computer-readable storage medium of claim 17, wherein the instructions for adjusting the speed at which the filament is provided to the hot-end comprise instructions for modifying one or more signals communicated to an extruder feeding the filament into the hot-end.

19. The computer-readable storage medium of claim 17, wherein the instructions, upon execution by the at least one processor, cause the at least one processor to perform additional operations of:
detecting an absence of the filament based at least on the first data or the second data; and
suspending generating the 3D object based on the detected absence of the filament.

20. The computer-readable storage medium of claim 17, wherein the first dimension comprises a first diameter, the second dimension comprises a second diameter of the filament, and wherein the instructions for determining the amount of the filament provided to a hot-end of the 3D printer comprise instructions for determining a cross-sectional area of the filament based on the first diameter and the second diameter.
